(19) United States
(12) Patent Application Publication
(10) Pub. No.: US 2023/0040644 A1
(43) Pub. Date: Feb. 9, 2023

(54) CONTROL DEVICE, NON-TRANSITORY COMPUTER-READABLE MEDIUM, AND AUTHENTICATION SYSTEM

(71) Applicant: KABUSHIKI KAISHA TOKAI RIKA DENKI SEISAKUSHO, Aichi (JP)

(72) Inventors: Hisamitsu HARADA, Aichi (JP); Motoki KAJITA, Aichi (JP); Hiroaki TSUZUKI, Aichi (JP); Yasunori TSUKAHARA, Aichi (JP)

(73) Assignee: KABUSHIKI KAISHA TOKAI RIKA DENKI SEISAKUSHO, Aichi (JP)

(21) Appl. No.: 17/769,480

(22) PCT Filed: Sep. 9, 2020
(86) PCT No.: PCT/JP2020/034118

§ 371 Date: Apr. 15, 2022

(30) Foreign Application Priority Data
Oct. 21, 2019 (JP) 2019-191802

(51) Int. Cl. G06F 21/32; G06F 21/35; G06F 3/01

(52) U.S. Cl. CPC G06F 21/32; G06F 21/35; G06F 3/017

(57) ABSTRACT

A reception interface (121) is configured to receive first authentication information related to first contactless authentication for authenticating a user and second authentication information related to second contactless authentication for authenticating the user in a different manner from the first contactless authentication. A processor (122) is configured to determine whether the first contactless authentication and the second contactless authentication are respectively approved based on the first authentication information and the second authentication information, and to control operation of a controlled device (21) in a case where it is determined that both the first contactless authentication and the second contactless authentication are approved.

### FIELD

The presently disclosed subject matter relates to a control device used in processing for authenticating a user of a controlled device, and a non-transitory computer-readable medium having stored a computer program adapted to be executed by a processor of the control device. The presently disclosed subject matter also relates to an authentication system using the control device.

### BACKGROUND

Japanese Patent Publication No. 2016-211334A discloses an authentication system adapted to be installed in a vehicle. In this system, contactless authentication is performed through communication with a smart key carried by a user via radio waves. When the contactless authentication is approved, a door of the vehicle is unlocked.

### SUMMARY

### Technical Problem

It is demanded to improve the convenience of a contactless authentication system.

### Solution to Problem

In order to meet the demand described above, an illustrative aspect of the presently disclosed subject matter provides a control device, comprising:

a reception interface configured to receive first authentication information related to first contactless authentication for authenticating a user and second authentication information related to second contactless authentication for authenticating the user in a different manner from the first contactless authentication; and

a processor configured to determine whether the first contactless authentication and the second contactless authentication are respectively approved based on the first authentication information and the second authentication information, and to control operation of a controlled device in a case where it is determined that both the first contactless authentication and the second contactless authentication are approved.

In order to meet the demand described above, an illustrative aspect of the presently disclosed subject matter provides a non-transitory computer-readable medium having stored a computer program adapted to be executed by a processor of a control device, the computer program being configured, when executed, to cause the control device to:

acquire first authentication information related to first contactless authentication for authenticating a user and second authentication information related to second contactless authentication for authenticating the user in a different manner from the first contactless authentication; and

determine whether the first contactless authentication and the second contactless authentication are respectively approved based on the first authentication information and the second authentication information; and

control operation of a controlled device in a case where it is determined that both the first contactless authentication and the second contactless authentication are approved.

In order to meet the demand described above, an illustrative aspect of the presently disclosed subject matter provides an authentication system, comprising:

an authentication information acquiring device configured to acquire first authentication information related to first contactless authentication for authenticating a user and second authentication information related to second contactless authentication for authenticating the user in a different manner from the first contactless authentication; and

a control device configured to determine whether the first contactless authentication and the second contactless authentication are respectively approved based on the first authentication information and the second authentication information, and to control operation of a controlled device in a case where it is determined that both the first contactless authentication and the second contactless authentication are approved.

Different from the contact authentication involving intentional contact with an object by a user, the contactless authentication would involve a case where authentication is unexpectedly approved based on a distance between the user and the controlled device, or the like. According to the configuration as described above, it is possible to facilitate avoidance of a situation that the controlled device happens to operate in a case where either contactless authentication is approved irrespective of the user's intention. In other words, by setting the approval of two different types of contactless authentication as a requirement for the operation of the controlled device, it is possible to cause the authentication system to recognize a situation that the user attempts to operate the controlled device with higher accuracy. Accordingly, it is possible to improve the convenience of the contactless authentication system.

### BRIEF DESCRIPTION OF DRAWINGS

FIG. 1 illustrates a functional configuration of an authentication system according to an embodiment.

FIG. 2 illustrates a case where the authentication system of FIG. 1 is installed in a vehicle.

FIG. 3 illustrates a flow of processing executed by a control device of FIG. 1.

FIG. 4 illustrates a flow of processing executed by the control device of FIG. 1.

FIG. 5 illustrates a case where the authentication system of FIG. 1 is installed in a vehicle.

FIG. 6 illustrates a flow of processing executed by the control device of FIG. 1.

### DESCRIPTION OF EMBODIMENTS

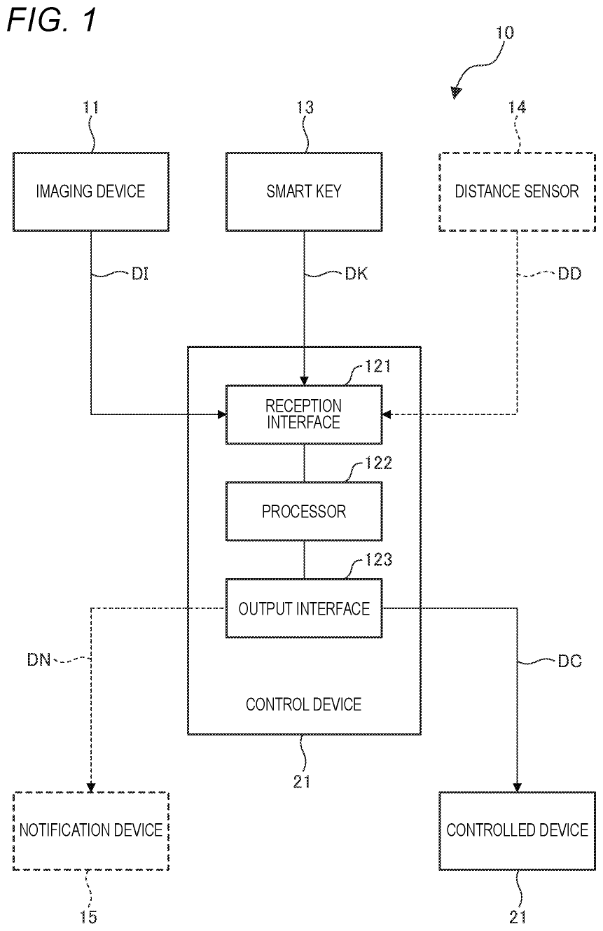

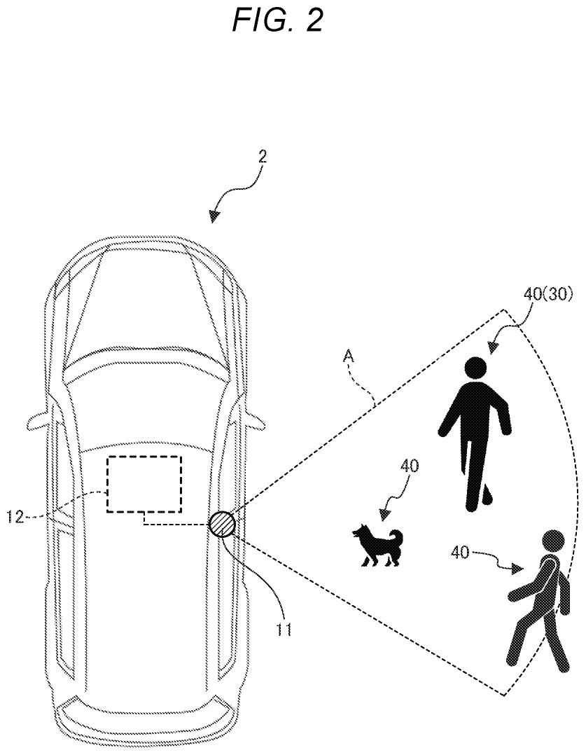

Examples of embodiments will be described in detail below with reference to the accompanying drawings. FIG. 1 illustrates a functional configuration of an authentication system 10 according to an embodiment. The authentication system 10 may be used, for example, to authenticate a user 30 of the vehicle 20 illustrated in FIG. 2 and to authorize the use of the vehicle 20 by the user 30. The vehicle 20 is an example of a mobile entity. The authentication system 10 includes an imaging device 11 and a control device 12.

The imaging device 11 is a device for acquiring an image of a prescribed imaging area. Examples of the imaging device 11 include a camera and an image sensor. The imaging device 11 is configured to output image data DI corresponding to the acquired image. The image data DI may be analog data or digital data.

The control device 12 includes a reception interface 121, a processor 122, and an output interface 123. The control device 12 may be disposed at an appropriate position in the vehicle 20.

The reception interface 121 is configured as an interface for receiving the image data DI. In a case where the image data DI is analog data, the reception interface 121 includes an appropriate conversion circuit including an A/D converter.

The processor 122 is configured to process the image data DI in the form of digital data. The details of the processing performed by the processor 122 will be described later. Based on the result of the processing, the processor 122 enables the output of control data DC from the output interface 123.

The control data DC is data for controlling operation of a controlled device 21 in the vehicle 20. Examples of the controlled device 21 include a door opening/closing device, a door locking device, an air conditioner, a lighting device, and an audio-visual equipment, each of which is equipped in the vehicle 20. The control data DC may be digital data or analog data. In a case where the control data DC is analog data, the output interface 123 includes an appropriate conversion circuit including a D/A converter.

The imaging device 11 is disposed at an appropriate position in the vehicle 20 in accordance with a desired imaging area. In the example illustrated in FIG. 2, the imaging device 11 is disposed on a right side portion of the vehicle 20, and defines an imaging area A on the right side of the vehicle 20. In other words, the imaging device 11 acquires an image of the imaging area A.

Various subjects 40 may enter the imaging area A. When a subject 40 enters the imaging area A, the subject 40 is captured in the image acquired by the imaging device 11. The subject 40 captured in the image is reflected in the image data DI. The authentication system 10 is configured to perform contactless authentication of the user 30 from among the subjects captured in the image data DI.

As used herein, the term “contactless authentication” means processing performed by the control device to acquire information relating to authentication under a condition that the control device 12 and the user 30 are not in contact with each other. The information relating to the authentication may be information used for the authentication, or may be a result of the authentication processing. The “condition that the control device 12 and the user 30 are not in contact with each other” may include a condition that there is no contact between the user 30 and a device to which the information to be authenticated is inputted, as well as a condition that there is no contact between the control device 12 and a device to which the information to be authenticated is inputted. The transmission of the information relating to the authentication from the device to which the information to be authenticated is inputted to the control device 12 may be performed by wired communication or may be performed by wireless communication. In the case of wireless communication, information relating to authentication may be transmitted to the control device 12 from a device to which information to be authenticated is inputted via an external server device connected to a communication network.

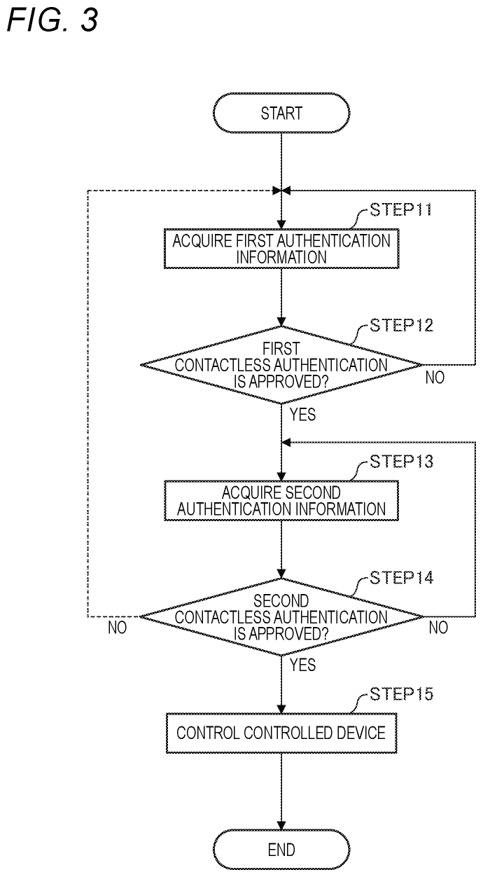

Referring to FIGS. 1 and 3, an example of the flow of the contactless authentication processing performed by the control device 12 will be described.

First, the processor 122 acquires first authentication information related to first contactless authentication for authenticating the user 30 through the reception interface 121 (STEP11).

Subsequently, the processor 122 determines whether the first contactless authentication is approved based on the first authentication information (STEP12). When it is determined that the first contactless authentication is not approved (NO in STEP 12), the processing returns to STEP11.

When it is determined that the first contactless authentication is approved (YES in STEP12), the processor 122 acquires second authentication information related to second contactless authentication for authenticating the user 30 through the reception interface 121 (STEP13). The second contactless authentication is performed with a manner different from the first contactless authentication. The timing at which the reception interface 121 receives the second authentication information and the timing at which the processor 122 acquires the second authentication information may be different from each other.

Subsequently, the processor 122 determines whether the second contactless authentication is approved based on the second authentication information (STEP14). When it is determined that the second contactless authentication is not approved (NO in STEP14), the processing returns to STEP13. Alternatively, the processing may return to STEP11.

When it is determined that the second contactless authentication is approved (YES in STEP14), the processor 122 permits the output of the control data DC from the output interface 123 for causing the controlled device 21 to perform a specified operation (STEP15).

In other words, the processor 122 is configured to determine whether each of the first contactless authentication and the second contactless authentication is approved based on the first authentication information and the second authentication information, and to control operation of the controlled device 21 in a case where it is determined that both the first contactless authentication and the second contactless authentication are approved.

Different from the contact authentication involving intentional contact with an object by a user, the contactless authentication would involve a case where authentication is unexpectedly approved based on a distance between the user and the controlled device, or the like. According to the configuration as described above, it is possible to facilitate avoidance of a situation that the controlled device happens to operate in a case where either contactless authentication is approved irrespective of the user's intention. In other words, by setting the approval of two different types of contactless authentication as a requirement for the operation of the controlled device, it is possible to cause the authentication system to recognize a situation that the user attempts to operate the controlled device with higher accuracy. Accordingly, it is possible to improve the convenience of the contactless authentication system.

In this example, face authentication is performed as the first contactless authentication, and gesture authentication is performed as the second contactless authentication. The face authentication is an example of authentication performed based on biometric information of a user. The gesture authentication is an example of authentication performed based on an action performed by a user.

In this case, the processor 122 acquires, as the first authentication information, image data DI corresponding to an image in which the face of the user 30 is captured from the imaging device 11 (STEP11).

Subsequently, the processor 122 determines whether a difference between the face of the user 30 captured in the image corresponding to the image data DI and a face registered in advance falls within an allowable range (STEP12). Since the processing relating to the determination can be appropriately performed using a known method, detailed descriptions will be omitted. When it is determined that the difference is not within the allowable range (NO in STEP12), the processing returns to STEP11.

When it is determined that the difference falls within the allowable range (YES in STEP12), the processor 122 acquires image data DI corresponding to an image in which the gesture of the user 30 is captured from the imaging device 11 as the second authentication information (STEP13).

Subsequently, the processor 122 determines whether a difference between the gesture of the user 30 captured in the image corresponding to the image data DI and a gesture registered in advance falls within an allowable range (STEP14). Since the processing relating to the determination can be appropriately performed using a known method, detailed descriptions will be omitted. When it is determined that the difference is not within the allowable range (NO in STEP14), the processing returns to STEP13 or STEP11.

When it is determined that the difference falls within the allowable range (YES in STEP14), the processor 122 permits the output of the control data DC from the output interface 123 for causing the controlled device 21 to perform the specified operation (STEP15). The control data DC may be, for example, data for causing a locking device of the vehicle 20 to unlock, data for opening a door of the vehicle 20, data for activating an air conditioner of the vehicle 20, or the like.

The face authentication would involve a case where the authentication is unexpectedly approved based on a distance between the user 30 and the imaging device 11 or the like. According to the configuration as described above, it is possible to facilitate avoidance of a situation that the controlled device 21 happens to operate in a case where the face authentication is approved irrespective of the intention of the user 30. For example, it is possible to facilitate avoidance of a situation that a door is unexpectedly unlocked or opened while the user walks beside the vehicle 20 or washes the vehicle 20. Accordingly, it is possible to improve the convenience of the contactless authentication system.

In addition, the combination of the face authentication and the gesture authentication has an advantage that two different types of contactless authentication can be performed with a common imaging device 11. Accordingly, it is not necessary to equip individual devices in the vehicle 20 for the two different types of contactless authentication, so that it is possible to suppress an increase in the space in the vehicle 20 occupied by the authentication device as well as an increase in the component cost in the vehicle 20.

Examples of the biometric information of the user to be subjected to the contactless authentication include a skeleton, a fingerprint pattern, a capillary pattern in a retina, an iris pattern, a vein pattern, a walking pattern, and a voice print pattern. The biometric information other than the voice print can be acquired with the imaging device 11.

Another example of the action performed by the user to be subjected to the contactless authentication includes a walking path and the like. Information relating to the gesture or the walking path of the user 30 can also be acquired by three-dimensional measurement using a distance sensor such as a radar sensor.

The gesture authentication may be performed as the first contactless authentication, whereas the face authentication may be performed as the second contactless authentication.

As another example, smart key authentication may be performed as the first contactless authentication, and the gesture authentication may be performed as the second contactless authentication. Smart key authentication is an example of authentication performed by a device capable of being carried by a user.

In this case, as illustrated in FIG. 1, the authentication system 10 includes a smart key 13. The smart key 13 is a device capable of being carried by the user 30 and capable of wirelessly transmitting key data DK. The key data DK includes unique authentication information assigned to each smart key 13 for discrimination from another smart key. The key data DK may be analog data or digital data.

In this case, the reception interface 121 of the control device 12 includes a communication interface for receiving the wirelessly transmitted key data DK. In a case where the key data DK is analog data, the reception interface 121 may be equipped with an appropriate conversion circuit including an AID converter.

The smart key 13 may be provided as an exclusive device, or may be provided as a function of a general-purpose device such as a portable information terminal.

In this case, the processor 122 acquires the key data DK as the first authentication information from the smart key 13 (STEP11).

Subsequently, the processor 122 determines whether the authentication information included in the key data DK matches authentication information registered in advance (STEP12). Since the processing relating to the determination can be appropriately performed using a known method, detailed descriptions will be omitted. When it is determined that the two items of authentication information do not match each other (NO in STEP12), the processing returns to STEP11.

When it is determined that the two items of authentication information match each other (YES in STEP12), the processor 122 acquires, as the second authentication information, the image data DI corresponding to the image in which the gesture of the user 30 is captured from the imaging device 11 (STEP13).

Subsequently, the processor 122 determines whether a difference between the gesture of the user 30 captured in the image corresponding to the image data DI and a gesture registered in advance falls within an allowable range (STEP14). When it is determined that the difference is not within the allowable range (NO in STEP14), the processing returns to STEP13 or STEP11.

When it is determined that the difference falls within the allowable range (YES in STEP14), the processor 122 permits the output of the control data DC from the output interface 123 for causing the controlled device 21 to perform the specified operation (STEP15).

The smart key authentication would involve a case where the authentication is unexpectedly approved based on a distance between the smart key 13 and the vehicle 20 or the like. According to the configuration as described above, it is possible to facilitate avoidance of a situation that the controlled device 21 happens to operate in a case where the smart key authentication is approved irrespective of the intention of the user 30. For example, it is possible to facilitate avoidance of a situation that a door is unexpectedly unlocked or opened while the user walks beside the vehicle 20 or washes the vehicle 20. Accordingly, it is possible to improve the convenience of the contactless authentication system.

The gesture authentication may be performed as the first contactless authentication, whereas the smart key authentication may be performed as the second contactless authentication.

As another example in which the same advantages can be obtained, the smart key authentication may be performed as the first contactless authentication, and the face authentication may be performed as the second contactless authentication.

In this case, the processor 122 acquires the key data DK as the first authentication information from the smart key 13 (STEP11).

Subsequently, the processor 122 determines whether the authentication information included in the key data DK matches authentication information registered in advance (STEP12). Since the processing relating to the determination can be appropriately performed using a known method, detailed descriptions will be omitted. When it is determined that the two items of authentication information do not match each other (NO in STEP12), the processing returns to STEP11.

When it is determined that the two items of authentication information match each other (YES in STEP12), the processor 122 acquires, as the second authentication information, the image data DI corresponding to the image in which the face of the user 30 is captured from the imaging device 11 (STEP13).

Subsequently, the processor 122 determines whether a difference between the face of the user 30 captured in the image corresponding to the image data DI and a face registered in advance falls within an allowable range (STEP14). When it is determined that the difference is not within the allowable range (NO in STEP14), the processing returns to STEP13 or STEP11.

When it is determined that the difference falls within the allowable range (YES in STEP14), the processor 122 permits the output of the control data DC from the output interface 123 for causing the controlled device 21 to perform the specified operation (STEP15).

The face authentication may be performed as the first contactless authentication, whereas the smart key authentication may be performed as the second contactless authentication.

In a case of the combination of the authentication performed with the biometric information of the user 30 and the smart key authentication, the smart key 13 may be provided with a function of acquiring the biometric information of the user 30. In this case, it is unnecessary to equip a device for acquiring biometric information in the vehicle 20, so that it is possible to suppress an increase in the space in the vehicle 20 occupied by the authentication device as well as an increase in the component cost in the vehicle 20.

As illustrated in FIG. 1, the authentication system 10 may include a distance sensor 14. The distance sensor 14 is installed at an appropriate position in the vehicle 20. The distance sensor 14 is a device for detecting a distance to the user 30, and outputting distance data DD corresponding to the detected distance. The distance data DD may be analog data or digital data.

The reception interface 121 of the control device 12 receives the distance data DD. In a case where the distance data DD is analog data, the reception interface 121 includes an appropriate conversion circuit including an AID converter.

In this case, the processor 122 of the control device 12 is configured to determine whether both the first contactless authentication and the second contactless authentication described above are approved, as well as whether the distance to the user 30 represented by the distance data DD is no greater than a threshold value, and to control the operation of the controlled device 21 in a case where the results of the determinations are positive.

As described above, the contactless authentication would involve a case where authentication is unexpectedly approved based on the distance between the user and the controlled device. In addition to the approvals of different types of contactless authentication, the requirement for causing the controlled device to operate includes a certain level of approach of the user. Accordingly, it is possible to cause the authentication system to recognize a situation that the use attempts to operate the controlled device with higher reliability. As a result, it is possible to further improve the convenience of the contactless authentication system.

The processor 122 may be configured to, in a case where the reception interface 121 receives one of the first authentication information and the second authentication information, allow the reception interface 121 to receive the other one of the first authentication information and the second authentication information.

As an example, in a case where the face authentication is performed as the first contactless authentication and the gesture authentication is performed as the second contactless authentication, the gesture authentication with respect to the user 30 is performed only with respect to the user 30 for whom the face authentication is approved. According to such a configuration, it is possible to suppress an increase in the processing load of the control device 12. As a result, it is possible to further improve the convenience of the contactless authentication system.

As another example, in a case where the smart key authentication is performed as the first contactless authentication and the gesture authentication is performed as the second contactless authentication, the imaging device 11 is activated to execute the gesture authentication only for the user 30 for whom the authentication with the smart key 13 is approved. According to such a configuration, not only it is possible to suppress an increase in the processing load of the control device 12, but also it is possible to suppress an increase in power consumption by the imaging device 11. As a result, it is possible to further improve the convenience of the contactless authentication system.

Additionally or alternatively, the processor 122 may be configured to allow the reception interface 121 to receive the first authentication information and the second authentication information in a case where a prescribed timing comes. An internal timer (not illustrated) included in the processor 122 may determine whether the prescribed timing comes. Examples of the prescribed timing include a timing when the user daily begins to use the vehicle 20, a reserved time for the vehicle 20 used in a car sharing service, and the like.

For example, in a case where at least one of the face authentication and the gesture authentication is performed as at least one of the first contactless authentication and the second contactless authentication, the imaging device 11 is activated when the prescribed timing comes. According to such a configuration, since it is not necessary for the imaging device 11 and the control device 12 to always wait for the input of the first authentication information and the second authentication information, it is possible to suppress an increase in the processing load and the power consumption of the control device 12. As a result, it is possible to further improve the convenience of the contactless authentication system.

As illustrated in FIG. 1, the authentication system 10 may include a notification device 15. The notification device 15 is a device for notifying the user 30 that the gesture can be acquired in a case where the gesture authentication is performed in either the first contactless authentication or the second contactless authentication.

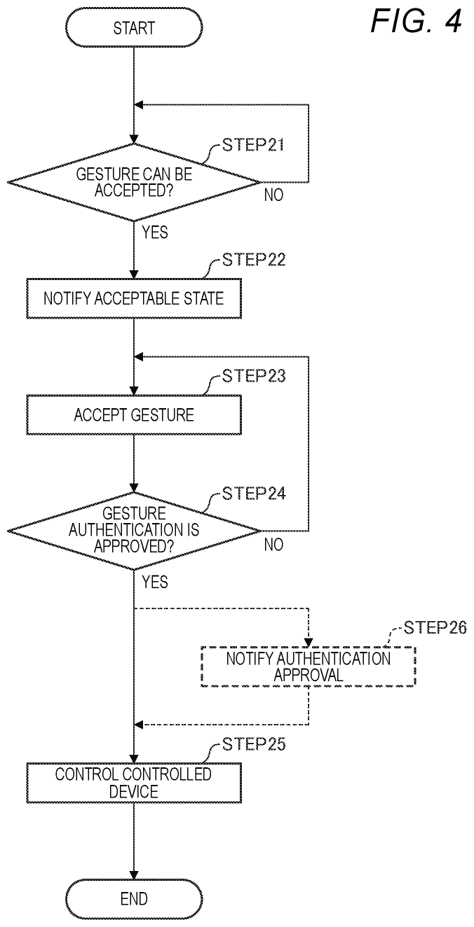

FIG. 4 illustrates a flow of processing that can be executed by the processor 122 of the control device 12 in such a configuration.

The processor 122 determines whether the image data DI corresponding to the image in which the gesture of the user 30 is captured can be acquired from the imaging device 11 as the first authentication information or the second authentication information (STEP21). The image data DI corresponding to the image in which the gesture of the user 30 is captured is an example of action information.

For example, it is determined whether the gesture can be acquired based on whether the imaging device 11 is activated to be able to acquire an image in which a gesture of the user 30 is captured. The processor 122 determines that the gesture can be acquired in a case where it is recognized that the imaging device 11 is activated to be able to acquire the image in which the gesture of the user 30 is captured. The imaging device 11 is an example of an action detecting device.

Alternatively, it is determined whether the gesture can be acquired based on whether the control device 12 is in a state capable of acquiring the image data DI corresponding to the image acquired by the imaging device 11. The processor 122 determines that the gesture can be acquired in a case where it is recognized that the control device 12 is in the state capable of acquiring the image data DI.

Alternatively, it may be determined whether a gesture as the second authentication information can be acquired based on whether the face authentication, the smart key authentication, or the like performed as the first contactless authentication described with reference to FIG. 3 is approved. The processor 122 determines that the gesture can be acquired in a case where it is recognized that the first contactless authentication is approved. The recognition that the first contactless authentication is approved may be made based on a determination performed by the processor 122 itself, or may be made based on a fact that the reception interface 121 receives information indicating that the first contactless authentication is approved.

The processing in STEP21 is repeated until it is determined that the gesture can be acquired (NO in STEP21). When it is determined that the gesture can be acquired (YES in STEP21), the processor 122 causes the notification device 15 to notify that the gesture can be acquired (STEP22).

Specifically, the processor 122 enables the output of notification data DN from the output interface 123. The notification data DN is data for controlling the operation of the notification device 15. The notification data DN may be digital data or analog data. In a case where the notification data DN is analog data, the output unit 123 includes an appropriate conversion circuit including a D/A converter.

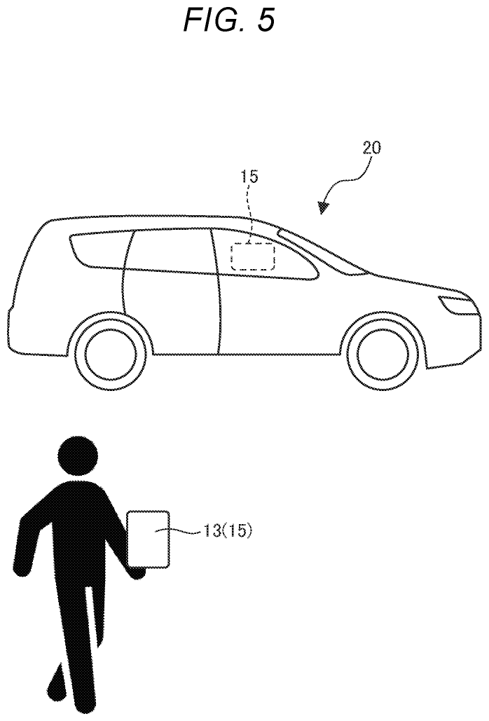

As an example, the notification device 15 may be implemented as a transparent display device disposed in a window of the vehicle 20 illustrated in FIG. 5. In this case, a notification image for notifying that the control device 12 can acquire a gesture of the user 30 is displayed on the transparent display device. The notification image may appropriately include characters, symbols, animations, and the like.

Next, as illustrated in FIG. 4, the processor 122 acquires a gesture from the user 30 (STEP23). In other words, the processor 122 acquires the image data DI corresponding to the image in which the gesture of the user 30 is captured from the imaging device 11 to execute the gesture authentication.

Specifically, the processor 122 determines whether a difference between the gesture of the user 30 captured in the image corresponding to the image data DI and a gesture registered in advance falls within an allowable range (STEP24). Since the processing relating to the determination can be appropriately performed using a known method, detailed descriptions will be omitted. When it is determined that the difference is not within the allowable range (NO in STEP24), the processing returns to STEP23.

When it is determined that the difference falls within the allowable range (YES in STEP24), the processor 122 permits the output of the control data DC from the output interface 123 for causing the controlled device 21 to perform the specified operation (STEP25). The control data DC may be, for example, data for causing a locking device of the vehicle 20 to unlock, data for opening a door of the vehicle 20, data for activating an air conditioner of the vehicle 20, or the like.

In the gesture authentication without involving contact actuation of an object, the user would hesitate to determine when to input the gesture. According to the configuration as described above, since it is notified to the user 30 through the notification device 15 that the control device 12 is ready to acquire the gesture input for authentication, it is possible to provide confidence for the user 30 who attempts to be subjected to the gesture authentication. Accordingly, it is possible to improve the convenience of the contactless authentication system.

In addition to or in place of the example in which the transparent display device described above is used, the notification function may be shared with a lamp equipped in the vehicle 20. For example, in the vehicle 20 illustrated in FIG. 5, at least one of a head lamp, a clearance lamp, a direction indicator lamp, a tail lamp, a brake lamp, and a reversing lamp can be used for notifying the information. The rule for the relationship between the lamps to be turned on/off and the information to be notified can be appropriately determined. The turning on/off operation of the lamp is an example of indication. In this case, it is possible to reduce the number of components required to be additionally installed in the vehicle 20.

In addition to or in place of the example in which the transparent display device described above is used, a notification device 15 capable of outputting a notification sound for notifying that the control device 12 can acquire the gesture of the user 30 may be equipped in the vehicle 20. The notification sound may appropriately include at least one of a single sound, a melody, a pseudo sound, and a message.

According to the notification performed by the notification device 15 with at least one of the indication and the sound, the user 30 can intuitively recognize that the control device 12 is ready to acquire the gesture.

In addition to or in place of each of the above examples in which the notification device 15 is equipped in the vehicle 20, the smart key 13 capable of being carried by the user 30 illustrated in FIG. 5 may be provided with a function as the notification device 15. In this case, the notification that the control device 12 is ready to acquire the gesture can be performed with at least one of indication, sound, and vibration.

As illustrated in FIG. 4, the processor 122 may cause the notification device 15 to notify that the gesture authentication is approved (STEP26). Specifically, when it is determined that the gesture of the user 30 captured in the image corresponding to the image data DI corresponds to the gesture registered in advance (YES in STEP24), the processor 122 permits the output of the notification data DN from the output interface 123 for causing the notification device 15 to notify that the gesture authentication is approved.

Based on the notification data DN, the notification device 15 notifies the user 30 that the gesture authentication is approved with at least one of indication, sound, and vibration. It is preferable that the notification that the gesture authentication is approved is performed in a manner different from the notification that the gesture can be acquired.

In the gesture authentication without involving contact actuation of an object, there would be a case where the user 30 feels anxiety as to whether the gesture input is appropriately recognized. According to the configuration as described above, since it is notified to the user 30 through the notification device 15 that the gesture authentication is approved, it is possible to provide confidence for the user 30. As a result, it is possible to further improve the convenience of the contactless authentication system.

The above descriptions with reference to FIGS. 4 and 5 assume an authentication system 10 in which two different types of contactless authentication are performed. However, the processing illustrated in FIG. 4 can be applied to an authentication system in which only the gesture authentication is performed.

The above descriptions with reference to FIGS. 4 and 5 assume that the gesture of the user 30 is detected by the imaging device 11. However, a walking path or the like of the user 30 may be detected with the imaging device 11. Alternatively, a walking path of the user 30 or the like may be detected with three-dimensional measurement using a distance sensor such as a radar sensor or the imaging device 11. In this case, the information corresponding to the walking path of the user is an example of the action information. A distance sensor such as a radar sensor is an example of the action detecting device.

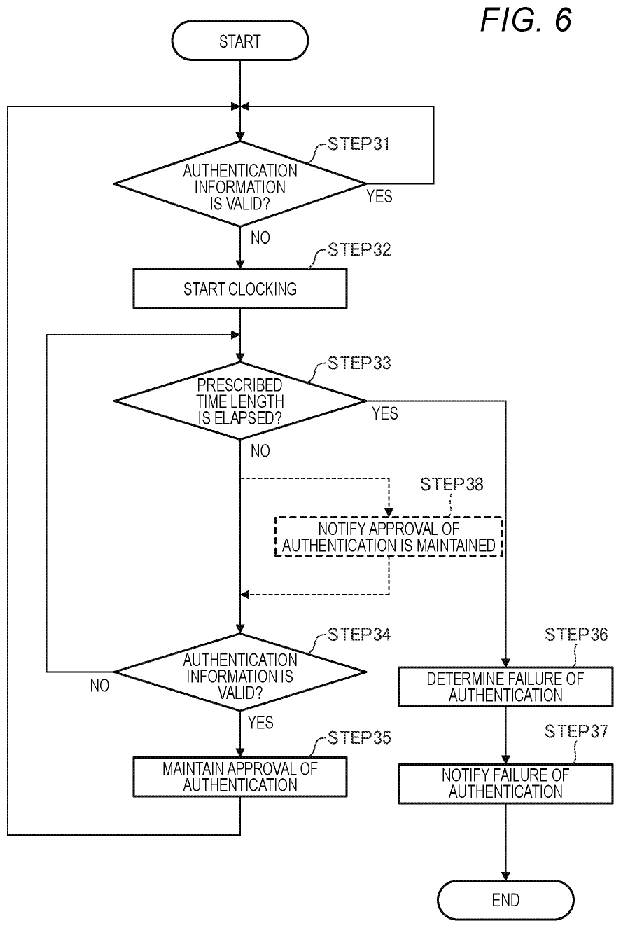

FIG. 6 illustrates an example of a flow of processing that can be performed by the processor 122 of the control device 12 in the authentication system 10 in which the operation of the controlled device 21 is controlled when both the first contactless authentication and the second contactless authentication are approved. The processing may be applied to at least one of the first contactless authentication and the second contactless authentication.

In the above authentication system 10, there would be a case where the authentication information used for the first contactless authentication becomes invalid while waiting for approval of the second contactless authentication after the first contactless authentication is approved. For example, in a case where the face authentication is performed as the first contactless authentication and the gesture authentication is performed as the second contactless authentication, the face authentication information may be invalid while the gesture authentication is performed. The above situation would be caused by a case where the direction or position of the face of the user 30 during the face authentication temporarily deviates from an appropriate state, a case where another person enters the imaging area A of the imaging device 11 and happens to be subjected to the face authentication, and the like.

The processor 122 determines whether the authentication information used for the contactless authentication of interest is valid (STEP31). For example, in a case where the face authentication is of interest, the image data DI corresponding to the image acquired by the imaging device 11 is the authentication information. The processor 122 determines whether a difference between the face of the user 30 captured in the image corresponding to the image data DI and the face registered in advance falls within an allowable range. When the difference falls within the allowable range, it is determined that the authentication information is valid. While it is determined that the authentication information is valid (YES in STEP31), the processing is repeated.

In a case where the authentication information has been invalid for the reason described above (NO in STEP31), the processor 122 starts clocking with an internal timer (not illustrated) (STEP32).

Subsequently, the processor 122 determines whether a threshold time length has elapsed since the start of the clocking (STEP33). The elapse of the threshold time length is an example of a prescribed condition. When it is determined that the threshold time length has not elapsed (NO in STEP33), the processor 122 determines whether the authentication information determined to be invalid in STEP31 becomes valid again (STEP34).

When it is determined that the authentication information becomes valid (YES in STEP34), the processor 122 maintains the condition that the authentication is approved (STEP35). Thereafter, the processing returns to STEP31.

When it is determined that the authentication information is still invalid (NO in STEP34), the processing returns to STEP33, so that the determination as to the elapse of the threshold time length is repeated. When it is determined that the threshold time length has elapsed (YES in STEP33), the processor 122 determines that the authentication is not approved (STEP36).

Subsequently, the processor 122 allows the output of the notification data DN from the output interface 123 for causing the notification device 15 to notify that the authentication is not approved. Based on the notification data DN, the notification device 15 notifies the user 30 that the failure of the authentication is determined with at least one of indication, sound, and vibration. The notification that the failure of the authentication is determined is made in a manner different from the notification that the gesture can be acquired and the notification that the gesture authentication is approved. Thereafter, the processing ends.

In other words, the processor 122 is configured to maintain the approval state of the authentication as long as the authentication information acquired until the threshold time length elapses is valid even if the authentication information once becomes invalid after the authentication of interest is approved.

In the case of the contactless authentication in which the authentication information is remotely acquired, there would be a case the authentication information becomes temporarily invalid due to a reason such as a behavior of the user or a communication failure. According to the configuration as described above, even if the authentication information becomes invalid, a grace period can be provided until the failure of the authentication is determined. As a result, even if the authentication information becomes temporarily invalid, as long as valid authentication information is obtained again until the prescribed condition is satisfied, the condition that the control of the controlled device 21 is enabled is maintained, so that the redo of the authentication is not forced. Accordingly, it is possible to improve the convenience of the contactless authentication system.

Particularly in a case where the approvals of two different types of contactless authentication are required to operate the controlled device 21, it is possible to suppress occurrence of a situation that both the contactless authentication are forced to be redid by a fact that the authentication information for either contactless authentication temporarily becomes invalid.

The requirement for maintaining the approved state of the authentication can be appropriately determined in accordance with the type of the contactless authentication of interest. However, the above-described condition as to the elapse of the threshold time length can be comprehensively applied for any types of contactless authentication. Plus, it is possible to suppress an increase in the processing load of the processor 122.

As illustrated in FIG. 6, the processor 122 may cause the notification device 15 to notify that it is waiting for the input of the authentication information while maintaining the approved condition of the authentication. Specifically, until the threshold time length elapses (NO in STEP33), the processor 122 permits the output of the notification data DN from the output interface 123 for causing the notification device 15 to notify that it is waiting for the input of the authentication information while maintaining the approved condition of the authentication (STEP38).

Based on the notification data DN, the notification device 15 notifies the user 30 that it is waiting for the input of the authentication information while maintaining the approved condition of the authentication with at least one of indication, sound, and vibration. The notification that it is waiting for the input of the authentication information while maintaining the approved condition of the authentication is performed in a manner different from the notification that the gesture can be acquired, the notification that the gesture authentication is approved, and the notification that the failure of the authentication is determined.

According to such a configuration, it is possible to prompt the user 30 to recognize a situation that the authentication information becomes invalid, and to prompt the user 30 to input the valid authentication information again. Accordingly, it is possible to facilitate maintenance of the approved condition of the authentication.

The above descriptions with reference to FIG. 6 assume an authentication system 10 in which two different types of contactless authentication are performed. However, the processing illustrated in FIG. 6 can be applied to an authentication system in which a single type of authentication is performed.

The processor 122 having each function described above can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. The ROM is an example of a non-transitory computer-readable medium having stored a computer program. The microprocessor designates at least a part of the program stored in the ROM, loads the program on the RAM, and executes the above-described processing in cooperation with the RAM. The above-mentioned computer program may be pre-installed in a general-purpose memory, or may be downloaded from an external server via a communication network and then installed in the general-purpose memory. In this case, the external server is an example of the non-transitory computer-readable medium having stored a computer program.

The processor 122 may be implemented by an exclusive integrated circuit capable of executing the above-described computer program, such as a microcontroller, an ASIC, and an FPGA. In this case, the above-described computer program is pre-installed in a memory element included in the exclusive integrated circuit. The memory element is an example of a non-transitory computer-readable medium in which a computer program is stored. The processor 122 may also be implemented by a combination of the general-purpose microprocessor and the exclusive integrated circuit.

The above embodiments are merely illustrative for facilitating understanding of the gist of the presently disclosed subject matter. The configuration according to each of the above embodiments can be appropriately modified or changed without departing from the gist of the presently disclosed subject matter.

At least a part of the authentication system 10 may be installed in a mobile entity other than the vehicle 20. Examples of the mobile entity include railways, aircrafts, and ships. The mobile entity may not require a driver.

At least a part of the authentication system 10 need not be installed in a mobile entity such as the vehicle 20. The authentication system 10 can be used to control operation of a monitoring device, a locking device, an air conditioner, a lighting device, an audio-visual equipment, and the like equipped in a house or a facility.

The control device 12 need not necessarily be equipped in the same mobile entity, house, facility, or the like as the imaging device 11 and the notification device 15. The control device 12 may be provided as an external device capable of communicating with at least one of the imaging device 11, the smart key 13, the distance sensor 14, and the notification device 15 via a communication network.

The present application is based on Japanese Patent Application No. 2019-191802 filed on Oct. 21, 2019, the entire contents of which are incorporated herein by reference.

1. A control device, comprising:
a reception interface configured to receive first authentication information related to first contactless authentication for authenticating a user and second authentication information related to second contactless authentication for authenticating the user in a different manner from the first contactless authentication; and
a processor configured to determine whether the first contactless authentication and the second contactless authentication are respectively approved based on the first authentication information and the second authentication information, and to control operation of a controlled device in a case where it is determined that both the first contactless authentication and the second contactless authentication are approved.

2. The control device according to claim 1,
wherein the first contactless authentication and the second contactless authentication are two ones selected from authentication performed based on biometric information of the user, authentication performed based on an action of the user, and authentication performed with a device capable of being carried by the user.

3. The control device according to claim 2,
wherein the first contactless authentication is the authentication performed based on biometric information of the user;
wherein the second contactless authentication is the authentication performed based on an action of the user; and
wherein the reception interface is configured to acquire the first authentication information and the second authentication information based on an image of the user acquired by an imaging device.

4. The control device according to claim 1,
wherein the reception interface is configured to receive distance information corresponding to a distance to the user;
wherein the processor is configured to control the operation of the controlled device in a case where both the first contactless authentication and the second contactless authentication are approved, and it is determined that the distance is no greater than a threshold value.

5. The control device according to claim 1,
wherein the processor is configured to, in a case where the reception interface receives one of the first authentication information and the second authentication information, allow the reception interface to receive the other one of the first authentication information and the second authentication information.

6. The control device according to claim 1,
wherein the processor is configured to allow the reception interface to receive the first authentication information and the second authentication information in a case where a prescribed timing comes.

7. A non-transitory computer-readable medium having stored a computer program adapted to be executed by a processor of a control device, the computer program being configured, when executed, to cause the control device to:
acquire first authentication information related to first contactless authentication for authenticating a user and second authentication information related to second contactless authentication for authenticating the user in a different manner from the first contactless authentication; and
determine whether the first contactless authentication and the second contactless authentication are respectively approved based on the first authentication information and the second authentication information; and
control operation of a controlled device in a case where it is determined that both the first contactless authentication and the second contactless authentication are approved.

8. An authentication system, comprising:
an authentication information acquiring device configured to acquire first authentication information related to first contactless authentication for authenticating a user and second authentication information related to second contactless authentication for authenticating the user in a different manner from the first contactless authentication; and
a control device configured to determine whether the first contactless authentication and the second contactless authentication are respectively approved based on the first authentication information and the second authentication information, and to control operation of a controlled device in a case where it is determined that both the first contactless authentication and the second contactless authentication are approved.

9. The authentication system according to claim 8,
wherein the control device is equipped in a mobile entity to control the controlled device equipped in the mobile entity.
